(19) United States
(12) Patent Application Publication
(10) Pub. No.: US 2026/0245157 A1
(43) Pub. Date: Aug. 20, 2026

(54) SYSTEMS AND METHODS FOR INDICATING A FLIGHT STATUS OF ONE OR MORE AMENITIES

(71) Applicant: UNITED AIRLINES, INC., Chicago, IL (US)

(72) Inventors: Adam Lang, Chicago, IL (US); Will Sammons, Chicago, IL (US); Lea Turnbull, Barrington, IL (US); Patricia Ameredes, Chicago, IL (US); Pamela M. Mylin, Mount Prospect, IL (US)

(21) Appl. No.: 19/055,991

(22) Filed: Feb. 18, 2025

(51) Int. Cl. G06Q 50/14

(52) U.S. Cl. CPC G06Q 50/14

(57) ABSTRACT

A system may update entries in an aircraft amenity database to reflect a current status of one or more amenities respectively offered by a plurality of aircrafts. The system may identify an entry in the aircraft amenity database based on a flight indicator for a planned flight. The system may retrieve the current status of the one or more amenities from the identified entry in the aircraft amenity database and transmit a notification to a user device indicating a flight status of the one or more amenities. The flight status is based on the current status retrieved from the aircraft amenity database for the planned flight.

### TECHNICAL FIELD

The present disclosure generally relates to aircraft data management, and, more particularly, to systems and methods for determining and indicating a flight status of one or more aircraft amenities.

### BACKGROUND

Airplane amenity offerings have expanded to include new and better options as personal user device adoption has proliferated. In particular, deployment of in-seat power, in-flight internet access, personal device entertainment options, etc. has increased to provide a better passenger experience and efficient resource allocation for airline operators (e.g., by replacing seat-back entertainment systems with personal user device access options). However, the proliferations of these options has increased the complexity for managing and communicating availability of amenities to passengers on a flight by flight basis to account for difference in availability based on maintenance issues, differing amenity deployment across different aircrafts, travel location specific availability, etc. Currently, systems utilize manual record keeping to maintain aircraft amenity records, which are frequently out of date and often wrong. This inaccuracy results in passengers being unaware of amenity offerings and may result in automated notification systems incorrectly communicating availability of amenities for amenities that other digital records correctly indicate as unavailable.

Furthermore, existing systems do not properly account for partial amenity availability. For example, existing systems rely primarily on static text that an aircraft may pass out of its coverage area, without definitively answering the question. For example, an aircraft with an internet system that cannot work over the Gulf of Mexico will tell customers the same “this internet may not work outside the continental U.S.” message for a Chicago to Houston flight (100% coverage), a Houston to Cancun flight (0% coverage), or a Chicago to Cancun flight (50% coverage), which leads to passenger confusion and uncertainty.

As such, there is a need for improved systems and methods to automatically determine amenity availability based on known aircraft data and location coverage for a planned flight. There is also a need to generate clear and unambiguous notification of the determined availability to passengers in advance of a planned flight.

### SUMMARY

In some aspects, the techniques described herein relate to a computer system including: one or more processors; and one or more non-transitory, computer-readable media storing instructions that, when executed by the one or more processors, cause the computer system to: update entries in an aircraft amenity database to reflect a current status of one or more amenities respectively offered by a plurality of aircrafts; identify an entry in the aircraft amenity database based on a flight indicator for a planned flight; retrieve the current status of the one or more amenities from the identified entry in the aircraft amenity database; and transmit a notification to a user device indicating a flight status of the one or more amenities, wherein the flight status is based on the current status retrieved from the aircraft amenity database for the planned flight.

In some aspects, the techniques described herein relate to a computer-implemented method for indicating a flight status of one or more amenities, the method including: updating, by one or more processors, entries in an aircraft amenity database to reflect a current status of one or more amenities respectively offered by a plurality of aircrafts; identifying, by the one or more processors, an entry in the aircraft amenity database based on a flight indicator for a planned flight; retrieving, by the one or more processors, the current status of the one or more amenities from the identified entry in the aircraft amenity database; and transmitting, by the one or more processors, a notification to a user device indicating the flight status of the one or more amenities, wherein the flight status is based on the current status retrieved from the aircraft amenity database for the planned flight.

### BRIEF DESCRIPTION OF THE DRAWINGS

The Figures described below depict various aspects of the system and methods disclosed therein. It should be understood that each Figure depicts an embodiment of a particular aspect of the disclosed system and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and instrumentalities shown, wherein:

FIG. 1A illustrates a block diagram of an example system for determining and indicating a flight status of one or more amenities, in accordance with various embodiments disclosed herein.

FIG. 1B is a flow diagram of an example method for determining and indicating a flight status of one or more amenities, in accordance with various embodiments disclosed herein.

FIGS. 2A-2D illustrate example user interface screens of a client device showing amenity flight status indications generated by the system of FIG. 1A.

FIG. 3 is a flow diagram of an example method for determining and indicating a flight status of one or more amenities, in accordance with various embodiments disclosed herein.

The Figures depict preferred embodiments for purposes of illustration only. Alternative embodiments of the systems and methods illustrated herein may be employed without departing from the principles of the invention described herein.

### DETAILED DESCRIPTION

The systems and methods described herein seamlessly integrate source-of-truth aircraft data from maintenance records, mechanic logs, etc. into accurate aircraft specific amenity data. The systems and methods described herein may then use the accurate aircraft specific amenity data on an on-demand basis to determine a current flight status of the various amenities and generate corresponding notifications for passengers. Furthermore, the systems and methods described herein provide improved interaction between various remote server and data storage systems used to generate amenity flight status data and systems for notifying passengers about the flight status data. In particular, the systems and methods include improved configurations for aggregating different data sources used to generate the flight status data and for dynamically presenting the generated flight status data to passengers.

This approach not only improves the accuracy of amenity availability information but also enhances the interaction between different remote server and data storage systems involved in generating and communicating this information. By aggregating data from diverse sources and dynamically presenting the generated flight status data to passengers, these systems and methods offer a more reliable and user-friendly solution.

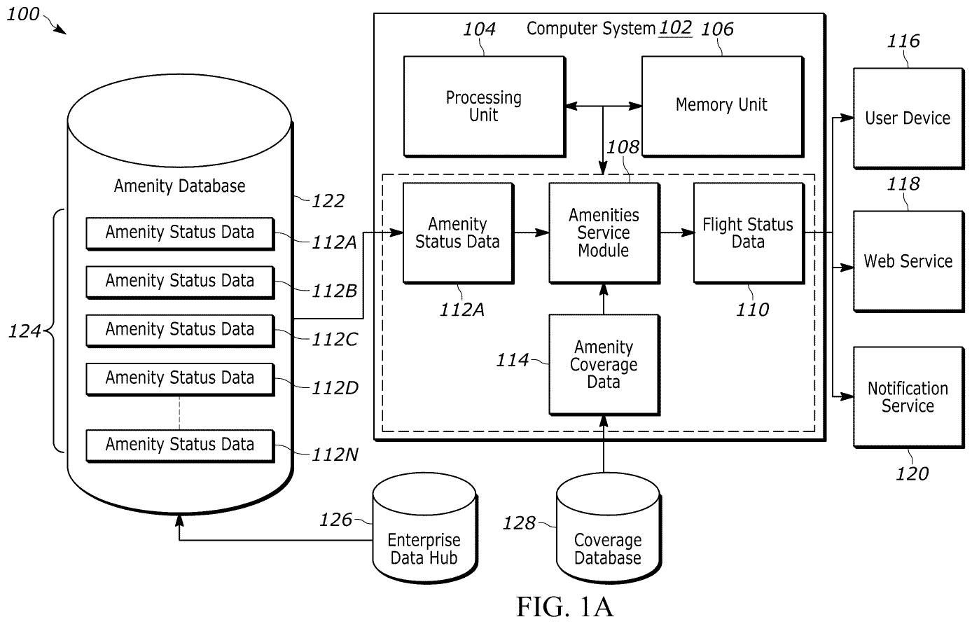

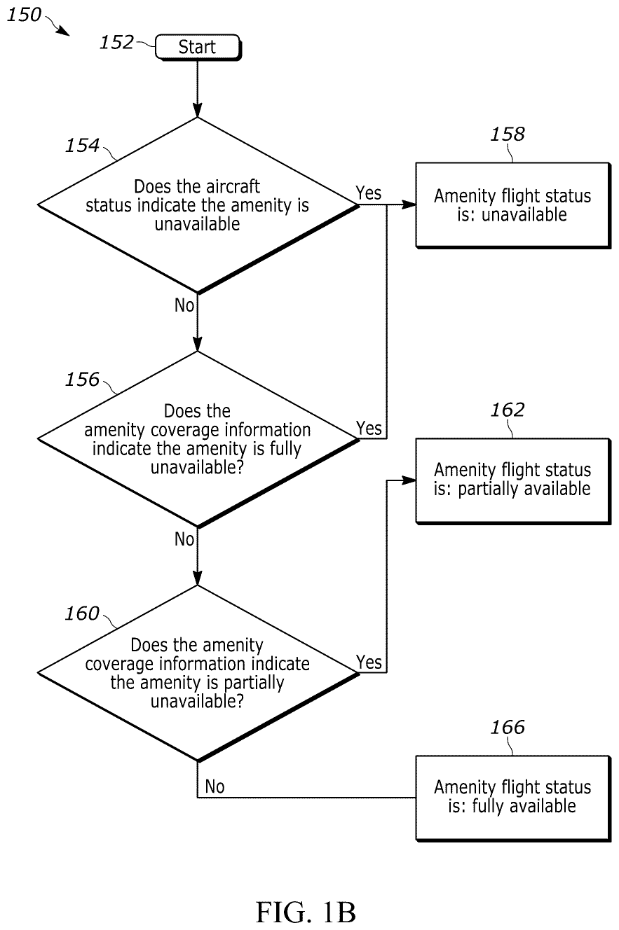

FIG. 1A illustrates a block diagram of an example system 100 for determining and indicating a flight status of one or more aircraft amenities, in accordance with various embodiments disclosed herein. The system 100 includes a computer system 102 such as a local server, remote cloud server, computer, tablet, etc. The computer system 102 may include a processing unit 104 and a memory unit 106.

Processing unit 104 includes one or more processors, each of which may be a programmable microprocessor or the like that executes software or other computing instructions stored in memory unit 106 to execute some or all of the functions of the system 100 as described herein. Processing unit 104 may include one or more graphics processing units (GPUs) and/or one or more central processing units (CPUs), for example. Alternatively, or in addition, one or more processors in processing unit 104 may be other types of processors (e.g., application-specific integrated circuits (ASICs), field-programmable gate arrays (FPGAs), etc.), and some of the functionality of the system 100 as described herein may instead be implemented in hardware.

Memory unit 106 may include one or more volatile and/or non-volatile memories. Any suitable memory type or types may be included in memory unit 106, such as read-only memory (ROM) and/or random access memory (RAM), flash memory, a solid-state drive (SSD), a hard disk drive (HDD), and so on. Collectively, memory unit 106 may store one or more software applications, the data received/used by those applications, and the data output/generated by those applications. In particular, the memory unit 106 may store instructions for specific modules of the computer system 102 as described herein.

In particular, the memory unit 106 stores the software and instructions that, when executed by processing unit 104, perform various functions of the computer system 102 related to execution of an amenities service module 108. In particular, the amenities service module 108 generates flight status data 110 that is indicative of a flight status of the one or more amenities that are offered by an aircraft assigned to a planned flight. The amenities service module 108 generates the flight status data 110 based on amenity status data 112A and/or amenity coverage information 114. The flight status data 110 generated by the amenities service module 108 indicates whether one or more amenities will be available or unavailable for the planed flight.

In some embodiments, the availability of various amenities may be dependent on an assigned seat location and/or a seat classification (e.g., first class, business class, premium plus, economy, etc.) for a passenger that is documented in user information received by the computer system 102. In these embodiments, the amenity status data 112A retrieved may be specific to the assigned seat location and/or a seat classification or the amenities service module 108 may be configured to identify sub-entries within the amenity status data 112A that are specific to the assigned seat location and/or a seat classification. In either case, the amenities service module 108 may generate the flight status data 110 to document amenity availability based on the assigned seat location and/or a seat classification.

Furthermore, the processing unit 104 transmits the flight status data 110 to a user device 116, a web service 118, and/or a notification service 120 that are operatively coupled to the computer system 102. The processing unit 104 may transmit the flight status data 110 automatically at a preconfigured time before a scheduled departure of the planned flight and/or in response to a request from the user device 116, the web service 118, and/or the notification service 120.

The amenity status data 112A may be associated with the particular aircraft for which the amenities service module 108 generates the flight status data 110. The processing unit 104 may receive the amenity status data 112A from an amenity database 122 that stores a plurality of data entries 124 that correspond to different amenity status data 112A, 112B, 112C, 112D . . . 112N relating to different specific aircrafts. Each of the plurality of data entries 124 may be indexed by a unique identifier that indicates the different specific aircraft. In some embodiments, the processing unit 104 may retrieve the amenity status data 112A using a flight indicator for a planned flight. In particular, the flight indicator may include the unique identifier by which the amenity status data 112A is indexed in the amenity database 122.

In general, the different amenity status data entries 112A, 112B, 112C, 112D . . . 112N correspond to a current or most recently updated status of the amenities offered by each of the different specific aircrafts. For example, the different amenity status data entries 112A, 112B, 112C, 112D . . . 112N correspond to a current status of in-flight internet access, in-seat power, seatback screen display, in-flight wireless audio, etc. Furthermore, the values of the different amenity status data entries 112A, 112B, 112C, 112D . . . 112N may be periodically updated to reflect data from an enterprise data hub 126. In some embodiments, the amenity database 122 may receive amenity data from the enterprise data hub 126 when the enterprise data hub 126 detects changes to amenity data. The enterprise data hub 126 may periodically synchronize with aircraft maintenance records to identify updates to the amenity data. The aircraft maintenance records may include aircraft minimum equipment lists and/or mechanic logs of the different aircrafts.

In some embodiments, at least one of the different amenity status data entries 112A, 112B, 112C, 112D . . . 112N may correspond to a generic or default amenity status that indicates general details about amenity availability for all fleet aircrafts instead of the details relating to a specific aircraft. The computer system 102 may retrieve the generic or default amenity status as the amenity status data entry 112A when the planned flight has not been assigned a particular aircraft when the computer system 102 is triggered to execute the amenities service module 108 to generate the flight status data 110.

The amenity coverage information 114 may be retrieved from a coverage database 128. In particular, the processing unit 104 may identify a plurality of travel locations for the planned flight using the flight indicator and retrieve the amenity coverage information 114 from the coverage database 128 based on the plurality of travel locations. The amenity coverage information 114 may indicate whether one of the aircraft amenities that is location dependent, such as inflight internet, is supported by each of the plurality of travel locations. The amenity coverage information 114 may indicate that the location dependent amenity is: available for the entire flight when all of the plurality of travel locations support the amenity; unavailable for the entire flight when none of the plurality of travel locations support the amenity; and partially available for a portion of the flight when at least one of the plurality of travel locations supports the amenity and at least one of the travel locations does not support the amenity.

With reference now to FIG. 1B, a flow diagram of a method 150 for determining the flight status data 110 based on the amenity status data 112A and the amenity coverage information 114 is shown. The method 150 may be performed by the processing unit 104 executing instructions stored on the memory unit 106 for executing the amenities service module 108.

At block 152, the method 150 includes initiating or starting the process for generating the flight status data 110.

At block 154, the method 150 includes determining whether the amenity status data 112A indicates that an amenity being reviewed is unavailable.

At block 156, the method 150 includes determining whether the amenity coverage information 114 indicates the amenity being reviewed is unavailable (e.g., none of the plurality of travel locations support the amenity).

At block 158, the method 150 includes setting the flight status data 110 for the amenity being reviewed to unavailable when the amenity status data 112A and/or the amenity coverage information 114 indicate that the amenity being reviewed is fully unavailable. In some embodiments, when the computer system 102 determines that the amenity is unavailable, the method 150 may also include transmitting a maintenance request to cause the amenity to be fixed so that the amenity is available in time for the planned flight.

At block 160, the method 150 includes determining whether the amenity coverage information 114 indicates that the amenity being reviewed is partially available when the amenity status data 112A and the amenity coverage information 114 do not indicate that the amenity being reviewed is fully unavailable.

At block 162, the method 150 includes setting the flight status data 110 for the amenity being reviewed to partially available when the amenity coverage information 114 indicates that the amenity is partially unavailable and the amenity status data 112A does not indicate that the amenity is unavailable.

At block 164, the method 150 includes setting the flight status data 110 for the amenity being reviewed to fully available when the amenity coverage information 114 indicates that the amenity is not partially unavailable and the amenity status data 112A does not indicate that the amenity is unavailable.

It should be appreciated that the operations of the method 150 may be performed in any suitable order (and/or in parallel), and/or may include fewer, additional, or different operations, in various embodiments.

With reference again to FIG. 1A, the processing unit 104 may execute various actions relating to the flight status data 110. For example, the processing unit 104 may be configured to initiate a refund process for any currently unavailable amenities for which a passenger may have prepaid (e.g., refunding fee for unviable in-flight internet).

Furthermore, the processing unit 104 may transmit the generated flight status data 110 to the user device 116, the web service 118, and/or the notification service 120 as a notification, data packet, etc. over a wired or wireless network connection. The user device 116 and the web service 118 may be configured to provide a user interface screen that provides an indication of the flight status data 110. For example, the user device 116 may display the user interface screen within a display component of the user device 116 as directed by a dedicated application, web browser, etc. The web service 118 may provide the user interface screen to a web browser application (including a web browser application on the user device 116), that requests the flight status data 110. The notification service 120 may be configured to send the flight status data 110 as part of a schedule or unscheduled push notification, email, text, etc. to an enrolled user account at a time prior to the planned flight.

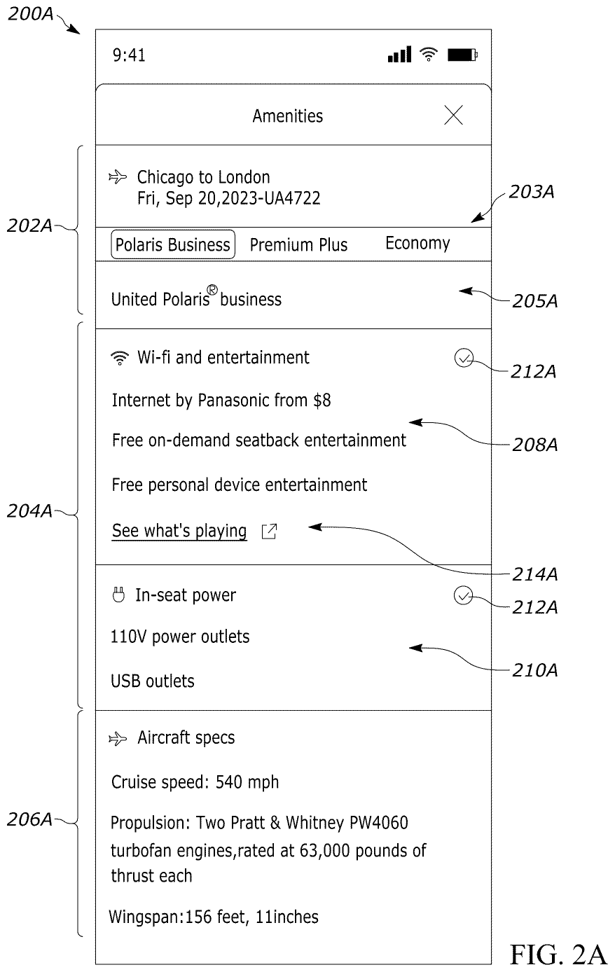

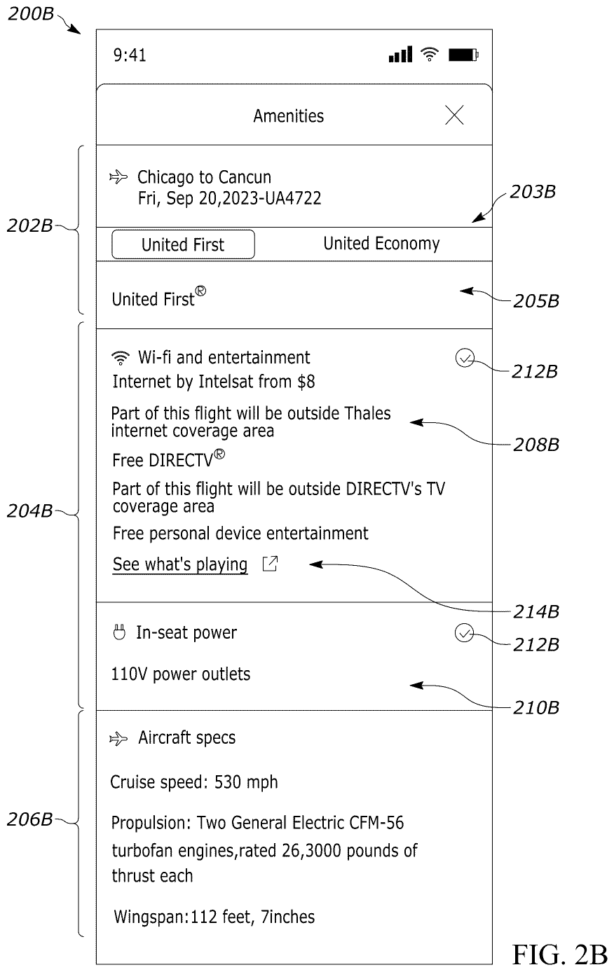

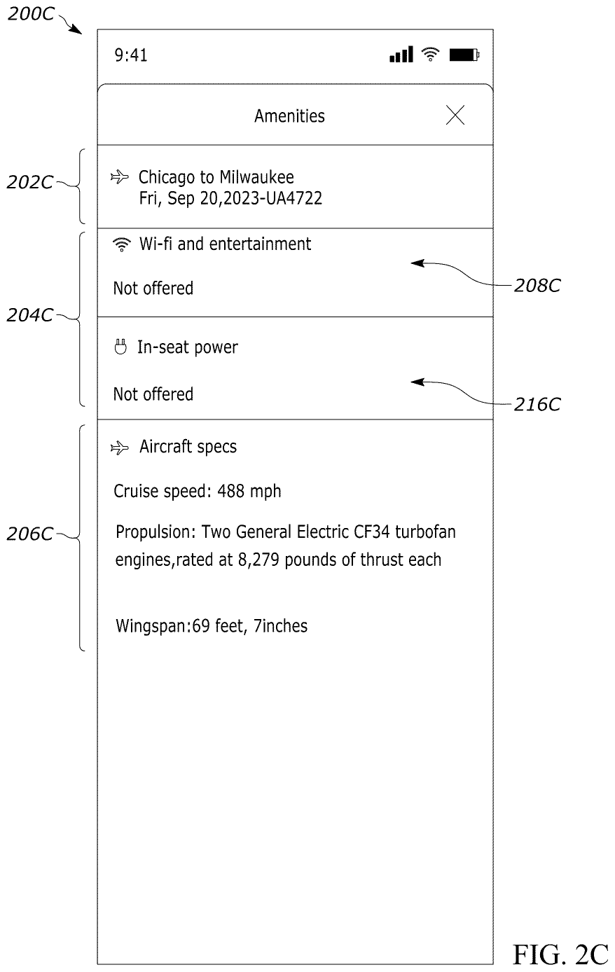

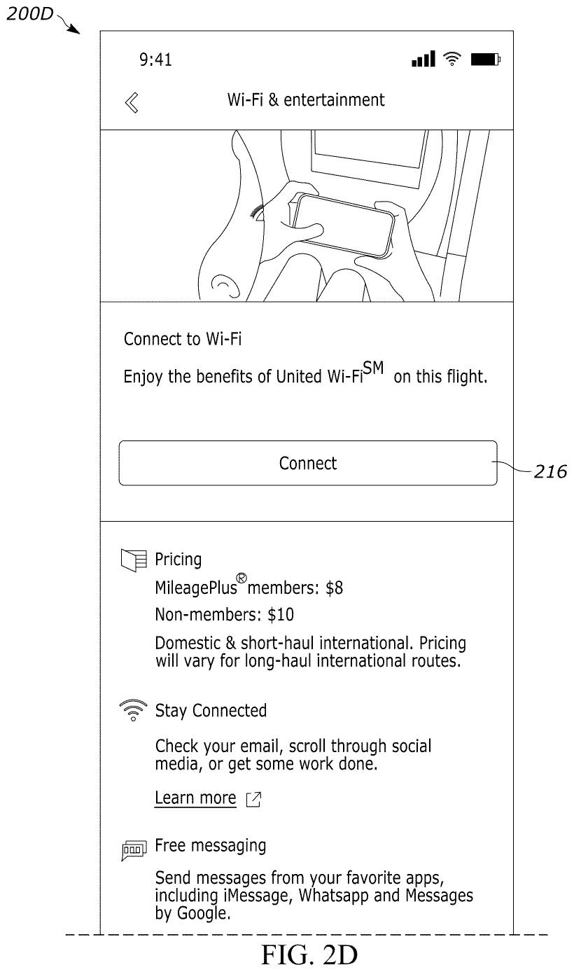

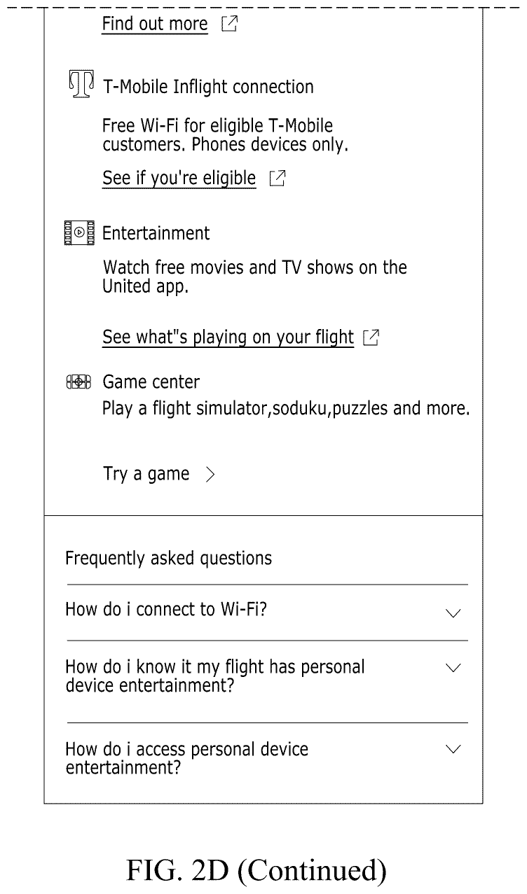

The user interface screen provided by the user device 116 and/or the web service 118 and the notification transmitted by the notification service 120 may be populated with one or more indicators noting the flight status data 110 for one or more amenities of the planned flight. Examples of such indicators are described below in connection with FIGS. 2A-2D.

FIG. 2A shows an example user interface screen 200A that may be provided by the user device 116 and/or the web service 118 of FIG. 1A. The user interface screen 200A includes a planned flight information section 202A, an amenity details section 204A, and an aircraft details section 206A. The planned flight information section 202A documents details of the planned flight such as the plurality of travel locations, the flight takeoff time, the flight number, etc. Furthermore, the aircraft details section 206A may include seat class selection buttons 203A (e.g., first class, business class, premium plus, economy, etc.) and a seat class indicator 205A. The seat class indicator 205A shows which of the seat class selection buttons 203A has been selected (e.g., business class) and indicates that the details contained in the details amenity details section 204A are specific to the selected seat class. The aircraft details section 206A documents features of the assigned aircraft such as the cruising speed, propulsion type, wingspan, etc.

As shown in FIG. 2A, the amenity details section 204A displays details on the amenities offered by the aircraft assigned to the planned flight, which include the flight status data 110 generated by the amenities service module 108 of FIG. 1A. In particular, the amenity details section 204A documents details 208A about in-flight internet or Wi-Fi and entertainment options and details 210A relating to in-seat power. As shown in FIG. 2A, the details 208A and 210A include corresponding check mark indicators 212A that signal to the user that in-flight internet or Wi-Fi and in-seat power are available amenities (e.g., that the relevant portions of the flight status data 110 indicate those amenities are available) for the planned flight. It should be appreciated that other possible indicators besides the check mark indicators 212A may be used to signal amenity availability. As shown in FIG. 2A, in some embodiments, the details 208A may include an interactive link 214A that when activated causes the device displaying the user interface screen 200A (e.g., the user device 116) to display a different user interface screen that includes additional details on the in-flight internet or Wi-Fi and entertainment options (see e.g., user interface screen 200D shown in FIG. 2D).

FIG. 2B shows an example user interface screen 200B that may be provided by the user device 116 and/or the web service 118 of FIG. 1A. The user interface screen 200B includes a planned flight information section 202B, an amenity details section 204B, and an aircraft details section 206B. The planned flight information section 202B is similar to the planned flight information section 202A and documents details of the planned flight such as the plurality of travel locations, the flight takeoff time, the flight number, etc. Furthermore, the aircraft details section 206B may include seat class selection buttons 203B (e.g., first class, business class, premium plus, economy, etc.) and a seat class indicator 205B. The seat class indicator 205B shows which of the seat class selection buttons 203B has been selected (e.g., first class) and indicates that the details contained in the details amenity details section 204B are specific to the selected seat class. The aircraft details section 206B is similar to the aircraft details section 206A and documents features of the assigned aircraft such as the cruising speed, propulsion type, wingspan, etc.

As shown in FIG. 2B, the amenity details section 204B is similar to the amenity details section 204A and displays details on the amenities offered by the aircraft assigned to the planned flight, which include the flight status data 110 generated by the amenities service module 108 of FIG. 1A. In particular, the amenity details section 204B documents details 208B about in-flight internet or Wi-Fi and entertainment options and details 210B relating to in-seat power. As shown in FIG. 2B, the details 208B and 210B include corresponding check mark indicators 212B similar to the corresponding check mark indicators 212A that signal to the user that in-flight internet or Wi-Fi and in-seat power are available amenities (e.g., that the relevant portions of the flight status data 110 indicate those amenities are available) for the planned flight. As shown in FIG. 2B, the details 208B may differ from the details 208A shown in FIG. 2A in that additional entertainment options are noted as provided amenities for the flight. Furthermore, the details 210B may differ from the details 210A in that fewer in-seat power options are included (e.g., the details 210B do not include USB power). As shown in FIG. 2B, in some embodiments, the details 208B may include an interactive link 214B similar to the interactive link 214A, which when activated causes the device displaying the user interface screen 200B (e.g., the user device 116) to display a different user interface screen that includes additional details on the in-flight internet or Wi-Fi and entertainment options (see e.g., user interface screen 200D shown in FIG. 2D).

FIG. 2C shows an example user interface screen 200C that may be provided by the user device 116 and/or the web service 118 of FIG. 1A. The user interface screen 200C includes a planned flight information section 202C, an amenity details section 204C, and an aircraft details section 206C. The planned flight information section 202C is similar to the planned flight information sections 202A, 202B and documents details of the planned flight such as the plurality of travel locations, the flight takeoff time, the flight number, etc. The planned flight information section 202C differs from the planned flight information sections 202A, 202B in that the planned flight information section 202C does not include any seat class buttons or indicators. The aircraft details section 206C is similar to the aircraft details sections 206A, 206B and documents features of the assigned aircraft such as the cruising speed, propulsion type, wingspan, etc.

As shown in FIG. 2C, the amenity details section 204C is similar to the amenity details sections 204A, 204B and displays details on the amenities offered by the aircraft assigned to the planned flight, which include the flight status data 110 generated by the amenities service module 108 of FIG. 1A. In particular, the amenity details section 204C documents details 208C about in-flight internet or Wi-Fi and entertainment options and details 210C relating to in-seat power. As shown in FIG. 2C, the details section 208C indicates that no in-flight internet or Wi-Fi and entertainment options are offered and the details section 210C indicates that no in-seat power option is offered (e.g., that the relevant portions of the flight status data 110 indicate those amenities are unavailable). As such, both sections fail to include check mark indicators similar to the corresponding check mark indicators 212A, 212B for the planned flight.

FIG. 2D shows an example user interface screen 200D that may be provided by the user device 116 and/or the web service 118 of FIG. 1A. The user interface screen 200D may display particular details on the in-flight internet or Wi-Fi and entertainment options for the planned flight and may be displayed in response to selection of a interactive link displayed on a different user interface screen (e.g., interactive links 214A, 214B shown in FIGS. 2A and 2B). In some embodiments, the user interface screen 200D may include an interactive user element 216 (e.g., a button) that enables the user device 116 or similar device on which the user interface screen 200D is presented to connect to the in-flight internet or Wi-Fi. In some embodiments, the interactive user element 216 may be disabled by the computer system 102 and/or the user device 116 when the in-flight internet or Wi-Fi is determined to be unavailable as indicated by the flight status data 110. For example, the interactive user element 216 may appear disabled in cases where the flight status data 110 indicates the in-flight internet or Wi-Fi is unavailable because of maintenance issues on aircraft equipment or the amenity coverage information 114 indicates unavailability of the in-flight internet or Wi-Fi at the plurality of travel locations. More specifically, the computer system 102 may transmit a control signal to the user device 116 to disable the interactive user element 216 in response to determining that the in-flight internet or Wi-Fi is unavailable.

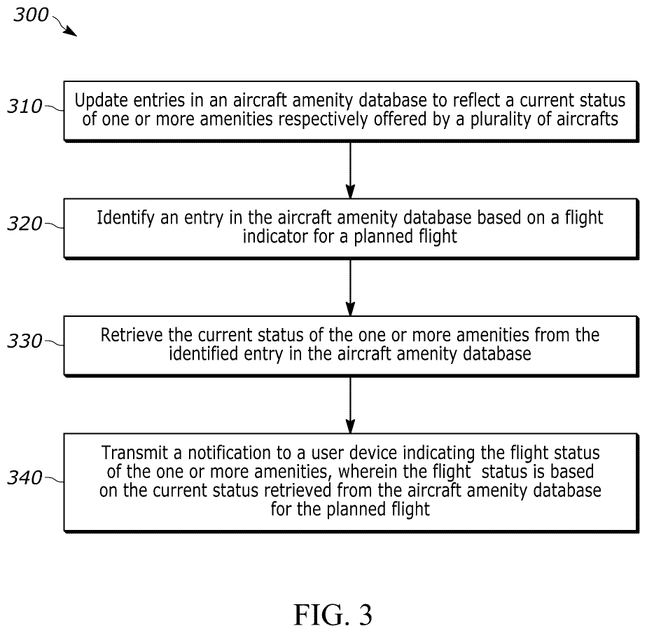

FIG. 3 shows a method 300 for generating the flight status data 110. The method 300 may be performed by the processing unit 104 executing instructions stored on the memory unit 106.

At block 310, the method 300 includes updating, by one or more processors, entries in an aircraft amenity database to reflect a current status of one or more amenities respectively offered by a plurality of aircrafts.

At block 320, the method 300 includes identifying, by the one or more processors, an entry in the aircraft amenity database based on a flight indicator for a planned flight.

At block 330, the method 300 includes retrieving, by the one or more processors, the current status of the one or more amenities from the identified entry in the aircraft amenity database.

At block 340, the method 300 includes transmitting, by the one or more processors, a notification to a user device indicating the flight status of the one or more amenities, wherein the flight status is based on the current status retrieved from the aircraft amenity database for the planned flight.

### ADDITIONAL CONSIDERATIONS

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The systems and methods described herein are directed to an improvement to computer functionality, and improve the functioning of conventional computers. Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules include a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

Upon reading this disclosure, those of skill in the art will appreciate still additional alternative structural and functional designs through the principles disclosed herein.

Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 812(f) unless traditional means-plus-function language is expressly recited, such as “means for” or “step for” language being explicitly recited in the claim(s).

1. A computer system comprising:
one or more processors; and
one or more non-transitory, computer-readable media storing instructions that, when executed by the one or more processors, cause the computer system to:
dynamically update entries in an aircraft amenity database to reflect a current status of one or more amenities respectively offered by a plurality of aircrafts;
identify an entry in the aircraft amenity database based on a flight indicator for a planned flight;
retrieve the current status of the one or more amenities from the identified entry in the aircraft amenity database; and
transmit a notification to a user device indicating an up-to-date flight status of the one or more amenities, wherein the flight status is based on the current status retrieved from the aircraft amenity database for the planned flight; and
transmit, as part of the notification, a control signal to the user device that causes one or more elements of a user interface on the user device to be modified based on the up-to-date flight status of the one or more amenities.

2. The computer system of claim 1 wherein the control signal causes the computer system to disable an interactive element presented within the user interface on the user device when the current status of the one or more amenities indicates that one of the one or more amenities is unavailable.

3. The computer system of claim 1 wherein the control signal causes the user interface on the user device to be populated with one or more indicators noting the current status of the one or more amenities retrieved from the aircraft amenity database.

4. The computer system of claim 1 wherein the flight status in the notification is further based on amenity coverage information and wherein the instructions, when executed by the one or more processors, cause the computer system to:
identify a plurality of travel locations for the planned flight; and
retrieve the amenity coverage information with respect to the plurality of travel locations from a coverage database.

5. The computer system of claim 4 wherein the flight status of the one or more amenities is unavailable when (1) the current status of the one or more amenities from the identified entry in the aircraft amenity database indicates that the one or more amenities are unavailable and/or (2) the amenity coverage information indicates that all of the plurality of travel locations do not support the one or more amenities.

6. The computer system of claim 4 wherein the flight status of the one or more amenities is partially available when (1) the current status of the one or more amenities from the identified entry in the aircraft amenity database indicates that the one or more amenities are available; (2) the amenity coverage information indicates that at least one of the plurality of travel locations supports the one or more amenities; and (3) the amenity coverage information indicates that at least one of the plurality of travel locations does not support the one or more amenities.

7. The computer system of claim 4 wherein the flight status of the one or more amenities is fully available when (1) the current status of the one or more amenities from the identified entry in the aircraft amenity database indicates that the one or more amenities are available and (2) the amenity coverage information indicates that all of the plurality of travel locations support the one or more amenities.

8. The computer system of claim 1 wherein the instructions, when executed by the one or more processors, cause the computer system to:
identify the entry in the aircraft amenity database based on the flight indicator, retrieve the current status of the one or more amenities from the identified entry in the aircraft amenity database, and transmit the notification to the user device automatically at a preconfigured time before a scheduled departure of the planned flight.

9. The computer system of claim 1 wherein the instructions, when executed by the one or more processors, cause the computer system to:
identify the entry in the aircraft amenity database based on the flight indicator, retrieve the current status of the one or more amenities from the identified entry in the aircraft amenity database, and transmit the notification to the user device in response to a request from the user device.

10. The computer system of claim 1 wherein to update the entries in the aircraft amenity database to reflect the current status of one or more amenities, the instructions, when executed by the one or more processors, cause the computer system to:
receive amenity data from an enterprise data hub when the enterprise data hub detects changes to amenity data.

11. The computer system of claim 10 wherein the enterprise data hub periodically synchronizes with aircraft maintenance records to identify updates to the amenity data.

12. The computer system of claim 11 wherein the aircraft maintenance records include aircraft minimum equipment lists and/or mechanic logs.

13. The computer system of claim 1 wherein the one or more amenities include at least one of in-flight internet access, in-seat power, seatback screen display, or in-flight wireless audio.

14. The computer system of claim 1 wherein the instructions further cause the computer system to:
when the current status indicates that one of the one or more amenities is unavailable, transmit a maintenance request to cause the amenity to be fixed so that the amenity is available in time for the planned flight.

15. A computer-implemented method for indicating a flight status of one or more amenities, the method comprising:
dynamically updating, by one or more processors, entries in an aircraft amenity database to reflect a current status of one or more amenities respectively offered by a plurality of aircrafts;
identifying, by the one or more processors, an entry in the aircraft amenity database based on a flight indicator for a planned flight;
retrieving, by the one or more processors, the current status of the one or more amenities from the identified entry in the aircraft amenity database; and
transmitting, by the one or more processors, a notification to a user device indicating an up-to-date flight status of the one or more amenities, wherein the flight status is based on the current status retrieved from the aircraft amenity database for the planned flight; and
transmitting, by the one or more processors and as part of the notification, a control signal to the user device that causes one or more elements of a user interface on the user device to be modified based on the up-to-date flight status of the one or more amenities.

16. The computer-implemented method of claim 15 wherein the control signal causes disabling of an interactive element presented within the user interface on the user device when the current status of the one or more amenities indicates that one of the one or more amenities is unavailable.

17. The computer-implemented method of claim 15 wherein the control signal causes the user interface on the user device to be populated with one or more indicators noting the current status of the one or more amenities retrieved from the aircraft amenity database.

18. The computer-implemented method of claim 15, further comprising:
identifying, by the one or more processors, a plurality of travel locations for the planned flight; and
retrieving, by the one or more processors, amenity coverage information with respect to the plurality of travel locations from a coverage database, wherein the flight status in the notification is further based on the amenity coverage information.

19. The computer-implemented method of claim 15 wherein updating the entries in the aircraft amenity database to reflect the current status of one or more amenities includes:
receiving, by the one or more processors, amenity data from an enterprise data hub when the enterprise data hub detects changes to amenity data.

20. The computer-implemented method of claim 15, further comprising:
when the current status indicates that one of the one or more amenities is unavailable, transmitting, by the one or more processors, a maintenance request to cause the amenity to be fixed so that the amenity is available in time for the planned flight.
